(19) United States
(12) Patent Application Publication
(10) Pub. No.: US 2011/0275353 A1
(43) Pub. Date: Nov. 10, 2011

(54) Methods and Apparatus of a Remote Monitoring System

(75) Inventor: JUN LIU, Vienna, VA (US)

(73) Assignee: JUN LIU, Vienna, VA (US)

(21) Appl. No.: 13/098,479

(22) Filed: May 1, 2011

Related U.S. Application Data
(60) Provisional application No. 61/329,567, filed on Apr. 30, 2010.

(51) Int. Cl. H04W 4/00

(52) U.S. Cl. 455/414.1

(57) ABSTRACT

In one aspect, an apparatus of a data storage and forward device comprises: a cellular phone interface, a controller, a memory, an internet connection and a status indicator, wherein the data sensed by the cellular phone is transferred and stored in the memory, and forwarded to the internet connection. In another aspect, the method of a remote patient monitoring system comprises: a cellular phone sensing and collecting data from a remote patient, a data storage/forward device bridging the connection between the phone and the internet, the data transmitting to a medical office via the bridged connection.

### RELATED APPLICATIONS INFORMATION

The application claims the benefit under 35 U.S.C. 119(e) of U.S. Provisional Patent Application Ser. No. 61/329,567, filed Apr. 30, 2010 and entitled “Methods and Apparatus of a Remote Monitoring System,” which is incorporated herein by reference in its entirety.

### BACKGROUND

A prior art system for remote patient monitoring is shown in FIG. 1. Sensor 102 is attached to a remote patient; the sensed data is transmitted wirelessly to a cellular phone 104, for example, via Bluetooth. Cellular phone 104 transmits the sensed data via Cellular Network 106. Cellular Network 106 is connected to Internet 108 which is connected to Medical Office 110. Ideally, this system provides remote patient monitoring in or near real-time. In reality, there are two major concerns for such a system. First, sensed data may be large in size, which consumes too much radio resource of a cellular network, which results in cellular network congestion, and in turn, causes sensed data not being reliably transmitted or having too long delay. Second, real-time monitoring via cellular network causes a liability issue: who is liable if the sensed data is transmitted unreliably or with too long delay?

There is a need to have a remote patient monitoring system which can transport sensed data reliably without impact to cellular network.

### SUMMARY

In one aspect, an apparatus of a data storage and forward device comprises: a cellular phone interface, a controller, a memory, an internet connection and a status indicator, wherein the data sensed by the cellular phone is transferred and stored in the memory, and forwarded to the internet connection.

In another aspect, the method of a remote patient monitoring system comprises: a cellular phone sensing and collecting data from a remote patient, a data storage/forward device bridging the connection between the phone and the internet, the data transmitting to a medical office via the bridged connection.

### BRIEF DESCRIPTION OF THE DRAWINGS

Features, aspects, and embodiments are described in conjunction with the attached drawings, in which:

FIG. 1 is a diagram illustrating a prior art remote patient monitoring system.

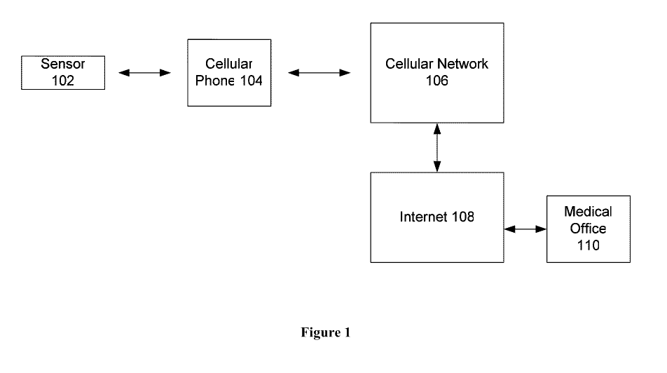

FIG. 2 is a diagram illustrating a remote patient monitoring system configured in accordance with the present invention.

FIG. 3 is a diagram illustrating a data store/forward device configured in accordance with the present invention.

### DETAILED DESCRIPTION

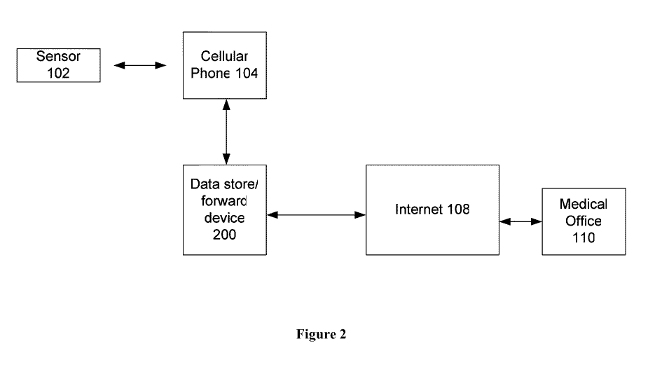

A remote patient monitoring system with sensed data being transported reliably is presented herein. The system diagram is shown in FIG. 2. Instead of transporting sensed data through cellular network, a data storage/forward device 200 is used to bridge the connection between cellular phone 104 and internet 108. Hence, sensed data can be reliably transported to internet 108, and to medical office 110. Here, cellular phone 104 may be replaced by a non-cellular device which can communicate with Sensor 102.

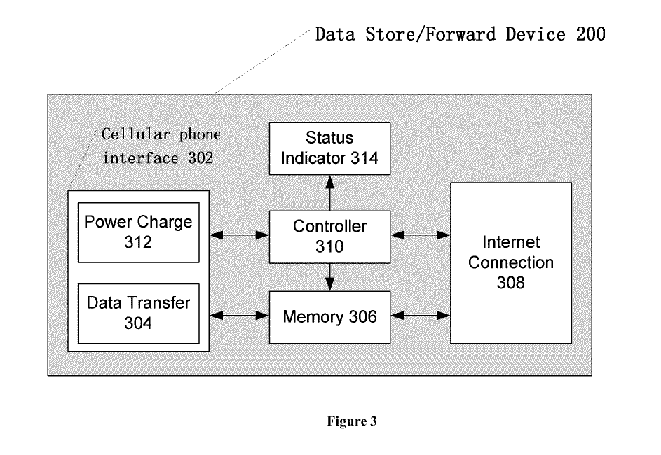

Without loss of generality, an example implementation of the data storage/forward device 200 is shown in FIG. 3. Cellular phone interface 302 connects a cellular phone 104 to a data storage/forward device 200. Interface 302 has a data transfer module which transports data between Device 200 and Phone 104. Through interface 302, sensed data stored in cellular phone 104 is transferred to memory 306. Data in memory 306 is transported via internet connection 308. Internet connection 308 consists of at least one of the following: LAN, Wi-Fi, Femtocell. If Internet connection 308 is Wi-Fi or Fetocell, the Wi-Fi router or Femtocell basestation which Device 200 communicates with is connected to Internet 108 via either DSL or cable. Optionally, the cellular phone interface 302 has a power charge module 312 which is used to charge the battery of phone 104.

Additionally, Device 200 has a status indicator 314, which shows the device status. The status consists of at least one of the following: 1) Sensed data from phone 104 is still on Device 200, 2) Time stamp when phone 104 connected to Device 200, 3) Sensed data from phone 104 is completely transported via internet connection 308, 4) Time stamp for sensed data from phone 104 completely transported via internet connection 308, 5) Phone 104 battery power is fully charged.

Controller 310 manages the operations and data transfer among other modules within Device 200.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. An apparatus of a data storage and forward device, comprising: a cellular phone interface, a controller, a memory, an internet connection and a status indicator, wherein the data sensed by the cellular phone is transferred and stored in the memory, and forwarded to the internet connection.

2. The apparatus of claim 1 wherein the status indication comprises at least one of the following: Sensed data from phone is still on the device, Time stamp when phone connected to the device, Sensed data from phone is completely transported via internet connection, Time stamp for sensed data from phone completely transported via internet connection.

3. The apparatus of claim 1 wherein the cellular phone interface has a power charge module and wherein the status indication includes the charging status of phone battery power.

4. The method of a remote patient monitoring system, comprising: a cellular phone sensing and collecting data from a remote patient, a data storage/forward device bridging the connection between the phone and the internet, the data transmitting to a medical office via the bridged connection.

5. The method of claim 4 wherein the internet connection is via one of the following: LAN, Wi-Fi and Femtocell.
